(19) United States
(12) Patent Application Publication
(10) Pub. No.: US 2006/0261769 A1
(43) Pub. Date: Nov. 23, 2006

(54) Electronic safety control system

(76) Inventor: John Christopher Rees, Swansea (GB)

Correspondence Address: JACOBS & KIM LLP, 1050 WINTER STREET, SUITE 1000, #1082, WALTHAM, MA, 02451-1401, US

(21) Appl. No.: 10/557,132

(22) PCT Filed: May 17, 2004
(86) PCT No.: PCT/GB04/02153

§ 371 Date: May 11, 2006

(30) Foreign Application Priority Data
May 17, 2003 (GB) 0311396.6

(51) Int. Cl. H02P 1/00

(52) U.S. Cl. 318/450

(57) ABSTRACT

An electronic safety control system comprising first and second elongate, flexible electrically-conductive sensing elements (18, 20) and electronic control means. The electronic control means are responsive, when a change in capacitance arising from the proximity of an object to said first element (18, 20) differs substantially from a change in capacitance arising from the proximity of said object to said second element, to provide an output signal for controlling a powered device (14). Thus, where the powered device (14) is used to displace a part (10) of a mechanism (8) towards another (12), the sensing elements (18, 20) may be fitted to one or other or both of the approaching surfaces of the two parts (10, 12) to prevent an object from becoming trapped therebetween.

The present invention relates to an electronic safety control system and, more particularly to a safety control system for preventing an object from becoming trapped between the approaching edges of two opposed parts of a mechanism in motion.

It is known to reduce the risk of an object, e.g. a human body part, becoming trapped between approaching surfaces of two opposed parts of a mechanism in motion, by providing a compressible strip along one of those surfaces, the strip containing opposed electrical contacts which are connected to form a circuit, to arrest the relative movement of the two parts, when the strip is compressed.

A similar arrangement instead uses a hollow compressible strip, which is connected to a pneumatic sensor for detecting the resulting increase in internal pressure when the strip is compressed.

However, both arrangements require physical contact between their respective strips and an obstructing object to arrest the relative movement of the opposed parts of a mechanism towards one another, and thus do not fully obviate the risk of damage to that object.

UK Patent Application No. 0018914.2 discloses an improved electronic safety control system comprising an elongate, flexible electrically-conductive sensing element and electronic control means responsive to a change in capacitance arising from the close proximity to the element of an object to provide an output signal for controlling a powered device.

Whilst such an arrangement, when installed such that the sensing element extends along one of the approaching surfaces of two opposed parts of a mechanism, requires no physical contact between the sensing element and an obstructing object, means are required for varying the level of responsiveness of the electronic control means, to take into account the progressive change in residual capacitance that will occur as the two opposed parts move closer towards one another.

In the specific electronic safety control system described in UK Patent Application No. 0018914.2, the electronic control means thereof are arranged to become less responsive to a change in capacitance when the two opposed parts of a mechanism come into close proximity, to prevent the magnitude of resulting change in capacitance from exceeding that which would normally cause relative motion of the two parts to be arrested.

We have now devised an arrangement which overcomes the limitations of existing electronic safety control systems.

In accordance with the present invention, as seen from a first aspect, there is provided an electronic safety control system comprising first and second elongate, flexible electrically-conductive sensing elements and electronic control means responsive, where a change in capacitance arising from the proximity of an object to said first element differs substantially from a change in capacitance arising from the proximity of said object to said second element, to provide an output signal for controlling a powered device.

Thus, the system may be installed with the first and second sensing elements extending substantially equal distances along at least part of the leading surface of a closure member or of a surface opposed to said leading surface, so that the electric control means will not respond to the substantially equal changes in capacitance that will arise as the two surfaces approach another, but only to a difference in the capacitance changes that would arise, were an object to obstruct the approach of those two surfaces.

Preferably the electronic control means comprise capacitance sensing means in the form of one or more charge transfer sensors, for example the QT 110 sensor produced by Quantum Research Group Limited, wherein a fixed charge is transferred from each sensing element to a sampling capacitor of known capacitance. The capacitance of the sensing element, which is affected by the proximity of the object, may then be calculated by measuring the voltage (or, in a burst-mode sensor, the accumulated voltage) across the sampling capacitor, as it is known that—
Cx=Cs·Vs/Vr

Where Cx is the unknown capacitance of the sensing element, Cs is the known capacitance of the sampling capacitor, Vs is the fixed voltage to which the sensing element is charged and Vr is the measured voltage transferred to the sampling capacitor.

Preferably each sensing element comprises at least one wire. Most preferably each sensing element comprises a pair of parallel, spaced-apart wires, incorporated into an elongate flexible strip. The strip is preferably sufficiently flexible to allow it be folded substantially flat, to form one or more angled bends in the strip. Preferably the system comprises at least one fixing device into which the strips may be fitted. Preferably the or each fixing device comprises an elongate strip having a suitably profiled channel for receiving a sensing strip and into which the sensing strip may be clipped or pressed to form an interference fit.

Where the sensing elements comprise respective pairs of parallel, spaced-apart wires, one wire of each pair of wires is preferably held at a substantially constant reference potential, and is most preferably grounded, such an arrangement having been found to substantially increase the consistency of capacitance measurements made over a period of time and/or between different operating environments and the uniformity of sensitivity of the sensing element along its length.

Where the sensing elements comprise respective pairs of parallel, spaced-apart wires, the distal ends of each pair of wires are preferably connected across a capacitor, such that each sensing element has a substantial residual capacitance. Thus, any discontinuity in either sensing element, due, for example, to a break or short in the element, will result in a substantial decrease in capacitance, which can be detected by the electronic control means, for example to generate an alarm.

The electronic control means are preferably arranged to respond when the capacitance arising from the proximity of the object to one of the sensing elements deviates, by more than a pre-determined amount, from the capacitance arising from the proximity of the object to the other sensing element.

Preferably at least the electronic control means are mains powered and are provided with an auxiliary power supply, preferably in the form of one or more re-chargeable batteries, to protect against a failure of the mains supply.

Preferably the electronic control means are arranged to emit an audible or visual signal warning signal whilst the powered device is operating.

Also in accordance with the present invention, as seen from the first aspect, there is provided a closure arrangement comprising at least one displaceable closure member, a powered device for operating the closure member, and an electronic safety control system, the electronic safety control system comprising first and second elongate, electrically-conductive elements extending substantially equal distances along at least part of the leading portion of the closure member or along a portion opposed to said leading portion and electronic control means responsive, where a change in capacitance arising from the proximity of an object said first element differs substantially from a change in capacitance arising from the proximity of said object to said second element, to provide an output signal for controlling the powered device.

Preferably the electronic control means are arranged to control the powered device to arrest an advancing movement of the closure member and/or to reverse the direction of movement of the closure member, in response to the change in capacitance.

The closure arrangement may comprise an arrangement for closing the gap between two opposed parts of a furniture assembly, e.g for adjusting the height or inclination of a chair, the powered device being an actuator, such as an electric, hydraulic or pneumatic actuator, for effecting said closure.

Alternatively, the closure arrangement may comprise an arrangement for closing a window on a vehicle, the first and second elongate, electrically-conductive elements extending substantially along at least part of the leading edge of the window or along a seal extending around the window aperture, against which the window seals.

One of the problems of electrically operated windows for vehicles is that the window can trap and even sever objects which become trapped between the window and the window seal. Traditionally, electric window mechanisms have comprised a current sensor on the drive motor which halts or reverses the motor when an increased current is sensed due to the additional loading when an object becomes trapped.

A disadvantage of this arrangement is that the current drawn by the motor can increase when the friction of the window in the window runners increases, say during cold weather or when aging of the runners occurs. This can lead to the window being unnecessarily halted or reversed. In order to overcome this problem, vehicle manufactures have tended to set a very wide current limit, with the result that small objects, such as children's fingers may not be sensed.

In order to overcome this problem, we have envisaged using a capacitive based sensor of the type disclosed in UK Patent Application No. 0018914.2. However, such sensors will only sense objects having a relatively high permittivity and as such may not sense objects having a low permittivity such as pens, pencils or perhaps children's fingers. Whilst the entrapment of a pen or pencil by the window is of minor importance, people tend to judge the effectiveness of sensing systems by its ability to sense the insertion of an object such as a pen or pencil. Hence it is important that sensing systems can sense such objects.

Thus, in accordance with this invention, as seen from a second aspect, there is provided an electronic safety control system comprising a plurality of elongate, flexible electrically-conductive members and electronic control means responsive, where a either change in capacitance arising from the proximity of an object to a said member is detected or where a change in the electrical conductivity between a pair of said members is detected, to provide an output signal for controlling a powered device.

In use, the elongate members can extend in or along the window seal of an electric window assembly for a vehicle. If a head, hand or other object having a relatively high permittivity is inserted into the window aperture whilst the window is being raised, the change in capacitance is sensed by the circuit and the window drive motor is halted or reversed.

However, when an object having a relatively low permittivity is inserted into the window aperture whilst the window is being raised, the flexible electrically-conductive members deform as the object becomes trapped, thereby causing a change in conductivity between a pair of members, which is sensed to halt or reverse the window drive motor.

In one embodiment, at least three elongate, flexible electrically-conductive members are provided, one of said members being a capacitive sensor and a pair of the other members forming the aforementioned pair.

Preferably, one of said pair of members or a forth member is held at a substantially constant reference potential for the capacitive sensor, and is most preferably grounded.

In an alternative embodiment, only two flexible electrically-conductive members are provided.

Preferably, the members extend in parallel and are spaced apart on a resilient carrier.

Also in accordance with the present invention, as seen from the second aspect, there is provided a closure arrangement comprising at least one displaceable closure member, a powered device for operating the closure member, and an electronic safety control system, the electronic safety control system comprising a plurality of elongate, flexible electrically-conductive members and electronic control means responsive, where a either change in capacitance arising from the proximity of an object to a said member is detected or where a change in the electrical conductivity between a pair of said members is detected, to provide an output signal for controlling the powered device.

The displaceable closure member preferably comprises a vehicle window, said elongate, flexible electrically-conductive members extending along a seal of the window.

Preferably, the elongate, flexible electrically-conductive members extending along a resilient carrier, preferably formed of elastomeric material.

Preferably, the carrier is extruded, the electrically-conductive members extending along an internal cavity of the extrusion.

An embodiment of the present invention will now be described by way of an example only and with reference to the accompanying drawings, in which:

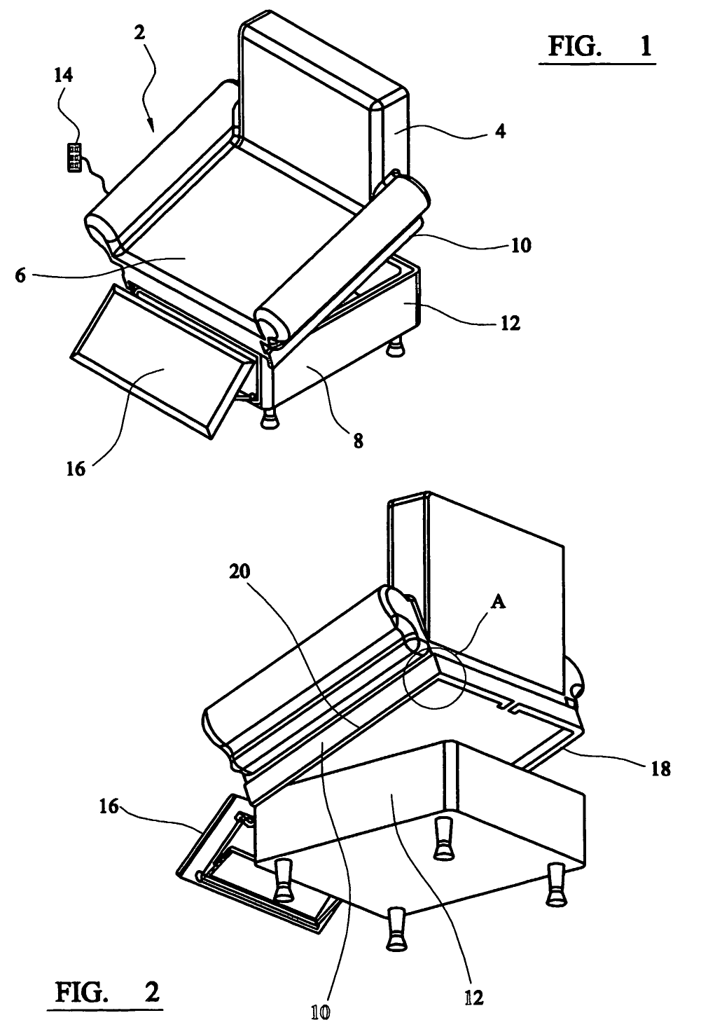

FIG. 1 is a first perspective view of a re-configurable chair in an inclined configuration, the chair incorporating an electronic safety control system in accordance with the first aspect of the present invention;

FIG. 2 is a second perspective view of the chair of FIG. 1;

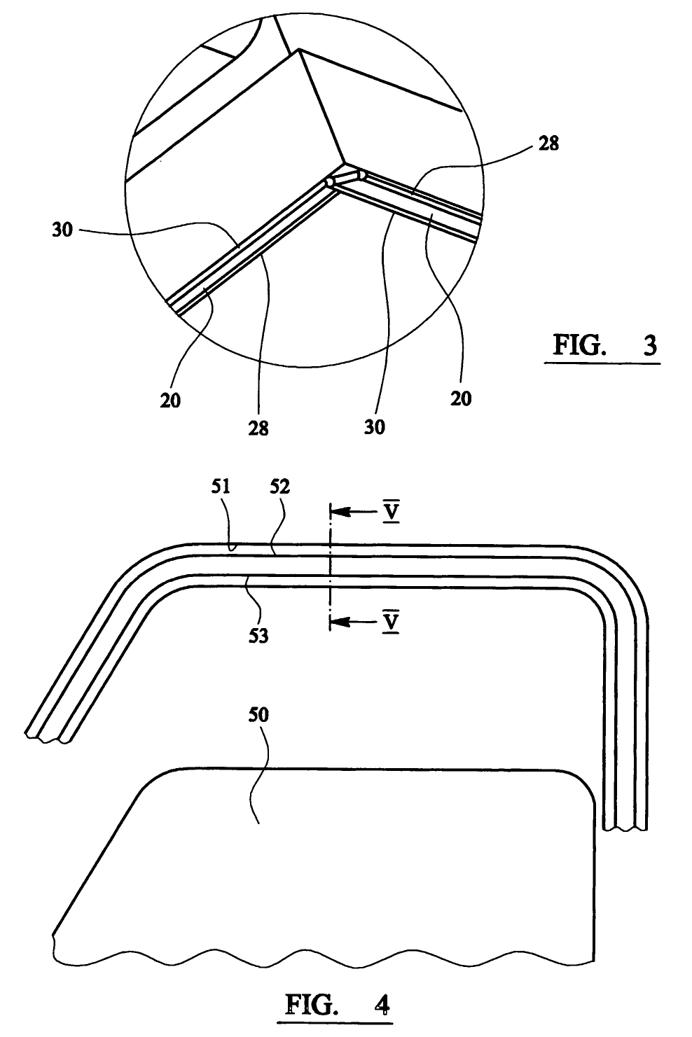

FIG. 3 is an enlarged view of the portion of the chair shown at A in FIG. 2;

FIG. 4 is a schematic diagram of an electric window assembly of a vehicle, the assembly being in accordance with the second aspect of the present invention;

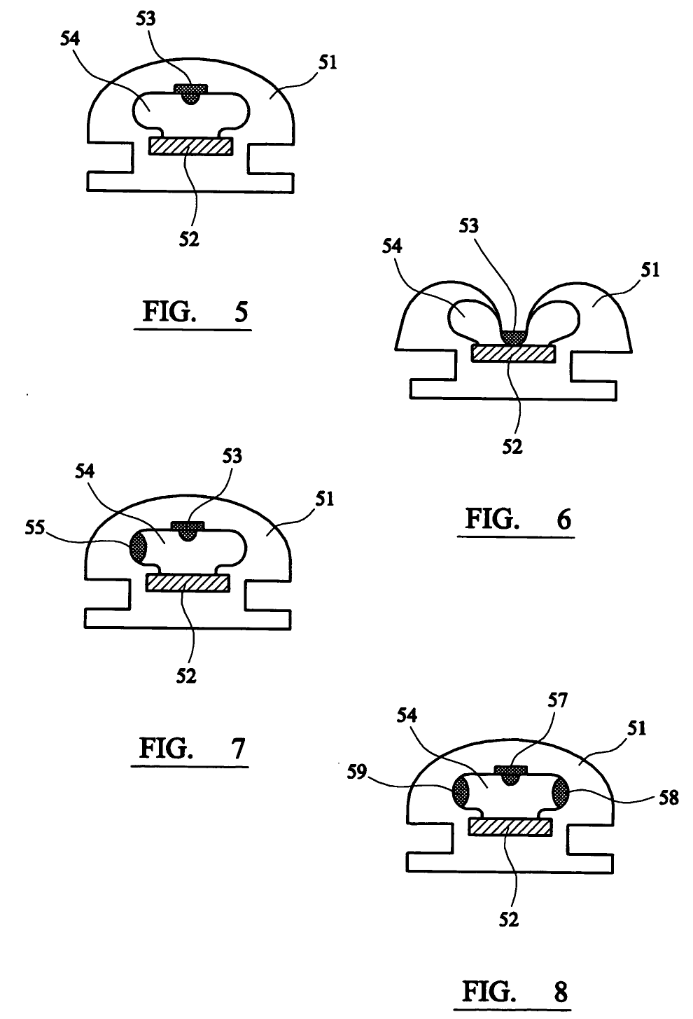

FIG. 5 is a sectional view along the line of V-V of FIG. 4, when the window seal is in it uncompressed state;

FIG. 6 is a sectional view along the line of V-V of FIG. 4, when the window seal is in it compressed state;

FIG. 7 is a sectional view through an uncompressed window seal of an second embodiment of electric window assembly of a vehicle, the assembly being in accordance with the second aspect of the present invention;

FIG. 8 is a sectional view through an uncompressed window seal of a third embodiment of electric window assembly of a vehicle, the assembly being in accordance with the second aspect of the present invention; and

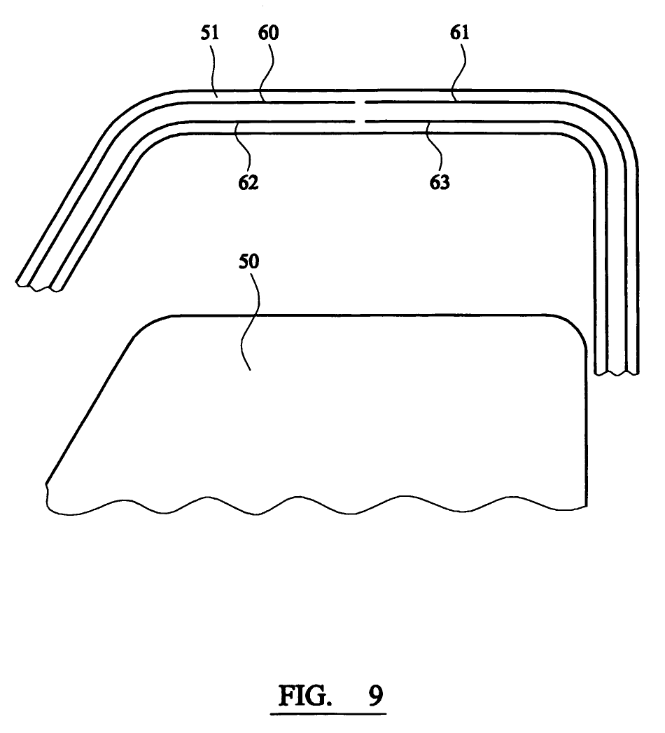

FIG. 9 is a schematic diagram of a fourth embodiment of an electric window assembly of a vehicle, the assembly being in accordance with the second aspect of the present invention.

Referring to FIG. 1, a re-configurable chair 2 is shown comprising a back 4 and squab 6 mounted to an articulated support frame 8, an upper portion 10 of the frame being arranged to pivot forwards, away from a lower portion 12 of the frame, as shown in FIG. 2, to assist in unseating a person from the chair.

The degree of inclination of the chair 2 is controlled by an electric motor (not shown), which is remotely operable via a handset 14.

A cushioned panel 16 is also attached to the front of the chair 2 and is arranged to pivot upwards about its upper edge (as shown) to provide a footrest.

In a preferred embodiment, a single drive motor (e.g. a linear actuator) is used both to adjust the degree of inclination of the chair 2 and of the panel 16, such that the with the squab 6 of the chair fully lowered, continued operation of the drive motor will raise the panel 16 to provide a footrest. When the panel is subsequently retracted, continued operation of the drive motor will then tip the squab 6 of the chair in a forwards direction.

As shown in FIG. 2, respective capacitive sensing elements 18, 20, of substantially equal length, extend along either side of the lower edge of the upper frame portion 10, the sensing elements 18, 20 being connected to electronic control means (not shown), which are arranged to respond, where the capacitance change arising from the close proximity to an obstructing object, such as a person's hand, of one of the elements 18, 20 differs, to a substantial extent, from that arising from the proximity of the same obstructing object to the other element, by arresting the movement of the upper frame portion 10 towards to the lower frame portion 12.

The electronic control means thus prevent the two frame portions 10, 12 from closing upon an obstructing object as the chair 2 is lowered, but allow the gap between the two frame portions to fully close, in the absence of an obstruction, as the progressive changes in capacitance that will arise from the increasing proximity of each of the two sensing elements 18, 20 to the base portion 12 of the frame will be substantially equal.

As shown in detail in FIG. 3, each of the sensing elements 18, 20 comprises a flexible strip incorporating a pair of parallel, spaced-apart wires, e.g. 28, 30, one wire of each pair being permanently grounded, so that a fixed potential applied periodically across the two wires may be used to determine the capacitance of the sensing element (which, as explained previously, will vary both according to the degree of separation between the upper and lower frame portions 10, 12 and to the proximity of the element of an obstruction).

The distal ends of each pair of wires are connected across a capacitor (not shown), such that each sensing element 18, 20 has a substantial residual capacitance, the electronic control means being arranged to detect any significant decrease in this level of capacitance, indicative of a break or short in the sensing element, for example to generate an alarm.

In order for each of the strips 18, 20 to follow the profile of its respective half of the upper frame portion to which it is attached, the strips may be folded, as shown in FIG. 4, to form bends at appropriate points along their lengths.

Referring to FIGS. 4 and 5 of the drawings, there is shown an electric window assembly of a vehicle in accordance with the second aspect of this invention, the assembly comprising a window glass 50 which is driven upwardly and downwardly by an electric motor (not shown). In its uppermost position, the window glass 50 seals against an extruded window seal 51 of elastomeric material, which is fitted to the window surround.

The extruded window seal 51 comprises an internal cavity 54 having opposed surfaces respectively carrying the conductors 52, 53 of a sensing element. One of the conductors 52 is permanently grounded, so that a fixed potential applied periodically across the two conductors may be used to determine the capacitance of the sensing element which, as explained previously, will vary according to the proximity of an obstruction having a relatively high permittivity. In this manner, the window drive motor can be halted or reversed when an obstruction is detected.

When an obstruction having a relatively low permittivity is inserted into the window aperture, the obstruction is undetected by the capacitive sensing. However, as the obstruction is forced against the widow seal 51 by the leading edge of the window glass 50, the obstruction deforms the seal 51 as shown in FIG. 6, thereby causing the conductors 52, 53 to come into contact. In this manner, the window drive motor can be halted or reversed when an obstruction is detected.

Referring to FIG. 7 of the drawings there is shown the seal of an alternative embodiment of an electric window assembly of a vehicle and like parts are given like reference numerals. In this embodiment, three conductors 52, 55, 56 are provided in the cavity 54 of the seal 51. As hereinbefore described, the conductor 52 acts as a ground or reference for a capacitive sensing conductor 55. The conductor 52 also acts as an element against which the third conductor 56 is shorted when the seal 51 is compressed.

Referring to FIG. 8 of the drawings there is shown the seal of an alternative embodiment of an electric window assembly of a vehicle and like parts are given like reference numerals. In this embodiment, four conductors 52, 57, 58, 59 are provided in the cavity 54 of the seal 51. The conductor 52 acts as an element against which the second conductor 57 is shorted when the seal 51 is compressed. The conductor 58 acts as a ground or reference for a capacitive sensing conductor 59.

Referring to FIG. 9 of the drawings, there is shown an electric window assembly of a vehicle in accordance with both the first and second aspects of this invention. In this embodiment, two capacitive sensing conductors 60, 61, of substantially equal length, respectively extend along the front and rear halves of the window seal 51. The conductors 60, 61 are connected to electronic control means (not shown), which are arranged to respond, where the capacitance change arising from the close proximity to an obstructing object, such as a person's hand, of one of the conductors 60, 61 differs, to a substantial extent, from that arising from the proximity of the same obstructing object to the other 61, 60, to arrest the movement of the window glass 50 towards to the seal 51.

The conductors 60, 61 may extend in parallel to respective ground or reference conductors 62, 63 as shown or a single ground or reference conductor.

Additionally, the sensing circuit can sense when the one of the two conductors 60, 61 becomes shorted to its adjacent ground or reference conductor when the seal 51 is compressed by an entrapped object, to arrest the movement of the window glass 50 towards to the seal 51.

Alternatively, each section of the seal may be provided with three or four conductors as shown in FIGS. 7 and 8.

An electronic safety control system in accordance with either the first and/or second aspect of this invention is simple and inexpensive in construction, yet provides a reliable way of sensing the presence of an object between two converging members.

1. An electronic safety control system comprising first and second elongate, flexible electrically-conductive sensing elements and electronic control means responsive to changes in capacitance, where when a change in capacitance arising from the proximity of an object to said first element differs substantially from a change in capacitance arising from the proximity of said object to said second element, an output signal is emitted for controlling a powered device, characterized in that the electronic control means is arranged to control the powered device and to arrest an advancing movement of a closure member operated by the powered device, in response to a differential change in detected capacitance between the first and second elements, wherein each sensing element comprises a pair of parallel, spaced-apart wires, incorporated into an elongate flexible strip.

2-11. (canceled)

12. An electronic safety control system as claimed in claim 1, wherein the electronic control means comprise capacitance sensing means in the form of one or more charge transfer sensors, wherein a charge is transferred from each sensing element to a sampling capacitor of known capacitance.

13-14. (canceled)

15. An electronic safety control system as claimed in claim 1 or claim 2, wherein each strip is sufficiently flexible to allow it be folded substantially flat, to form one or more angled bends in the strip.

16. An electronic safety control system as claimed in claim 3, comprising at least one fixing device into which the strips may be fitted.

17. An electronic safety control system as claimed in claim 4, wherein the or each fixing device comprises an elongate strip having a suitably profiled channel for receiving a sensing strip and into which the sensing strip may be clipped or pressed to form an interference fit.

18. An electronic safety control system as claimed in claim 1, wherein one wire of each said pair of wires is held at a substantially constant reference potential.

19. An electronic safety control system as claimed in claim 6, wherein said one wire of each said pair of wires is grounded.

20. An electronic safety control system as claimed in claim 1 wherein the distal ends of each said pair of wires are connected across a capacitor, such that each sensing element has a substantial residual capacitance.

21. An electronic safety control system as claimed in claim 8, wherein said electronic control means are arranged to detect a decrease in capacitance due to a break or short in one or other of said sensing elements.

22. An electronic safety control system as claimed in any preceding claim, wherein said electronic control means are arranged to respond when the capacitance arising from the proximity of said object to one of said sensing elements deviates, by more than a pre-determined amount, from the capacitance arising from the proximity of said object to the other sensing element.

23. An electronic safety control system as claimed in any preceding claim, wherein at least said electronic control means are mains powered and are provided with an auxiliary power supply, to protect against a failure of the mains supply.

24. An electronic safety control system as claimed in any preceding claim, wherein said electronic control means are arranged to emit an audible or visual warning signal whilst the powered device is operating.

25. A closure arrangement comprising at least one displaceable closure member, a powered device for operating the closure member, and an electronic safety control system, the electronic safety system comprising first and second elongate, electrically-conductive sensing elements extending substantially equal distances along at least part of the leading surface of the closure member or of a surface opposed to said leading surface with the electronic control means being arranged, to provide an output signal for controlling the powered device to arrest advancing movement of the closure member in response to a differential change in detected capacitance between the first and second elements, wherein each sensing element comprises a pair of parallel, spaced-apart wires, incorporated into an elongate flexible strip.

26. A closure arrangement as claimed in any preceding claim, wherein said electronic control means are arranged to control the powered device to arrest an advancing movement of the closure member, in response to the change in capacitance.

27. (canceled)

28. A closure arrangement as claimed in any preceding claim for closing the gap between two opposed parts of a furniture assembly.

29. A closure arrangement as claimed in claim 15 for adjusting the height or inclination of a chair.
